(19) United States
(12) Patent Application Publication
(10) Pub. No.: US 2015/0183465 A1
(43) Pub. Date: Jul. 2, 2015

(54) VEHICLE ASSISTANCE DEVICE AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/261,872

(22) Filed: Apr. 25, 2014

(30) Foreign Application Priority Data
Dec. 27, 2013 (TW) 102148597

(51) Int. Cl. B62D 15/02

(52) U.S. Cl. CPC B62D 15/0265

(57) ABSTRACT

Exemplary vehicle assistance method includes obtaining a number of continuous images of a scene. The method creates a number of 3D models of the scene corresponding to the obtained images of the scene. The method can determine a turning direction according to the operation on an input unit, and comparing the created 3D models of scene with stored preset 3D models of the special movable objects to determine whether one or more movable objects exist behind the turning direction of a vehicle. The method determines a speed of one movable object when one or more movable objects exist behind the turning direction of the vehicle. The method then determines a turning angle of the vehicle. The method controls a driving unit to drive a limiting unit to limit a largest turning angle of two front wheels as the determined turning angle of the vehicle.

### FIELD

The present disclosure relates to vehicle assistance devices, and particularly, to a vehicle assistance device capable of preventing an accidental impact and a related method.

### BACKGROUND

A driver must be aware of the environment around a vehicle when driving the vehicle. Especially, when the driving direction of the vehicle needs to be changed, at times, the driver must determine whether one or more movable objects exist behind the vehicle, and whether the distance between the vehicle and the one or more movable objects behind the vehicle is greater than a preset value. Only when the distance between the vehicle and the one or more movable objects behind the vehicle is greater than the preset value, the movement direction can be changed. However, if the one or more movable objects behind the vehicle are not seen by the driver or the distance between the vehicle and the one or more movable objects behind the vehicle estimated by the driver is greater than the real distance, an accidental impact will occur.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a vehicle assistance device, in accordance with an exemplary embodiment.

FIG. 2 is an illustrative view showing an angle determining module of the vehicle assistance device of FIG. 1 determining a turning angle of the vehicle.

FIG. 3 is a flowchart of a vehicle assistance method, in accordance with an exemplary embodiment.

### DETAILED DESCRIPTION

The embodiments of the present disclosure are now described in detail, with reference to the accompanying drawings.

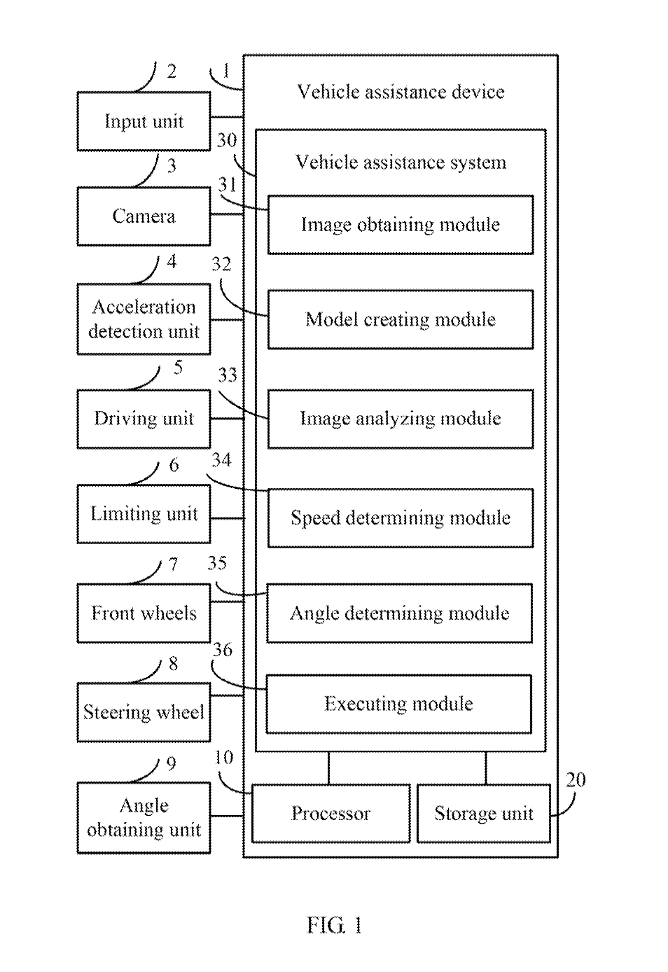

FIG. 1 illustrates an embodiment of a vehicle assistance device 1. The vehicle assistance device 1 can be within a vehicle 100 or connected thereto. The vehicle assistance device 1 can be used to prevent the vehicle 100 from occurring an accidental impact. The vehicle assistance device 1 is connected to an input unit 2, at least one camera 3, a speed detection unit 4, a driving unit 5, a limiting unit 6, two front wheels 7, and a steering wheel 8. The camera 3 is configured to capture images. The input unit 2 is configured to receive a manual operation. The speed detection unit 4 is configured to detect a speed of the vehicle 100. The vehicle 100 includes the front wheels 7 and the steering wheel 8.

The vehicle assistance device 1 can determine whether one or more movable objects exist behind the vehicle 100 in response to user operation on the input unit 2 and according to the images of the area captured by the camera 3. In addition, the vehicle assistance device 1 can determine the speed of one movable object relative to the vehicle 100 according to the images of the area captured by the camera 3 when one or more movable objects exist behind the vehicle 100. The vehicle assistance device 1 can determine the speed of the one movable object according to the speed of the vehicle 100 detected by the speed detection unit 4 and the determined speed of one movable object relative to the vehicle 100. The vehicle assistance device 1 can further determine a turning angle of the vehicle 100 according to the speed of the vehicle 100 and the speed of the movable object. In addition, the vehicle assistance device 1 can control the driving unit 5 to drive the limiting unit 6 to limit the angle of the front wheels 7 able to be turned to be less than or equal to the determined turning angle of the vehicle 100.

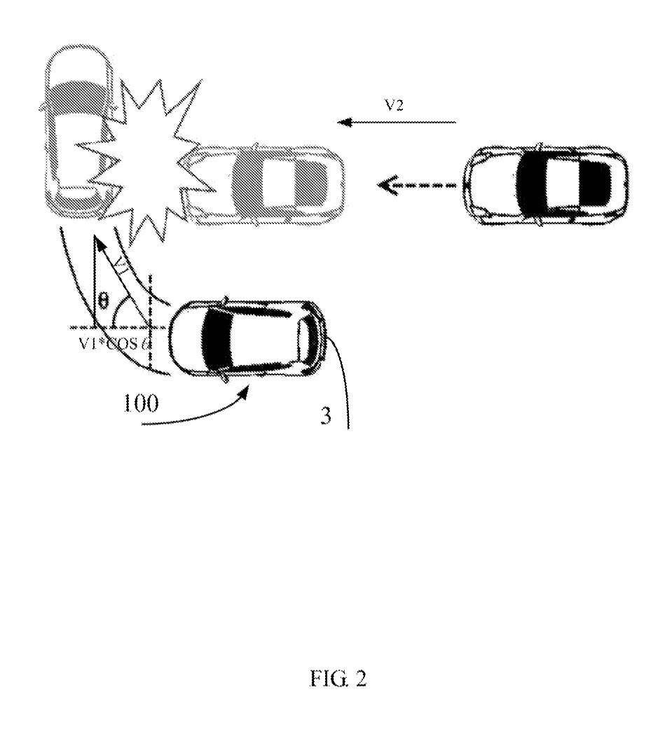

In the embodiment, the input unit 2 is a lamp control rod (not shown). The operation on the input unit 2 can control the turned on of a corresponding lamp (not shown) to inform a driver of another vehicles or another passer-by to be aware of the vehicle 100. For example, the operation of pushing the input unit 2 forward to control the turned on of the right lamp indicates that the turning direction of the vehicle 100 is right, and the operation of pulling the input unit 2 backward to control the turned on of the left lamp indicates that the turning direction of the vehicle 100 is left. The present disclosure, can be implemented with other controls. In the embodiment, the operation on the steering wheel 8 is after the operation on the input unit 2. FIG. 2 shows that in the embodiment, only one camera 3 is employed to illustrate the disclosure. The camera 3 is fixed on the rear of the vehicle 100 to capture the surrounding image behind the vehicle 100, in order to generate images of the scene. In at least one embodiment, the camera 3 is a Time of Flight (TOF) camera. Each captured image of the scene includes distance information indicating the distance between the camera 3 and each object captured by the camera 3.

In the embodiment, the vehicle assistance device 1 includes at least one processor 10 and a storage unit 20. A vehicle assistance system 30 is applied in the vehicle assistance device 1. In the embodiment, the vehicle assistance system 30 includes an image obtaining module 31, a model creating module 32, an image analyzing module 33, a speed determining module 34, an angle determining module 35, and an executing module 36. One or more programs of the above function modules can be stored in the storage unit 20 and executed by the processor 10. In general, the word “module,” as used herein, refers to logic embodied in hardware or firmware, or to a collection of software instructions, written in a programming language. The software instructions in the modules can be embedded in firmware, such as in an erasable programmable read-only memory (EPROM) device. The modules described herein can be implemented as either software and/or hardware modules and can be stored in any type of computer-readable medium or other storage device. The processor 10 can be a central processing unit, a digital processor, a single chip, for example. The storage unit 20 can be a hard disk, a compact disk, a flash memory, for example.

In the embodiment, the storage unit 20 stores a number of preset 3D models of the special movable objects, for example, vehicles and passers-by, such as. The storage unit 20 further stores a capturing speed of the camera 3, a safe distance between the vehicle 100 and the movable object, and a turning time of the vehicle 100. Each preset 3D model of the special movable object has one unique name and a number of characteristic features. The preset 3D models of the special movable objects can be respectively created based on a number of images of the special movable objects pre-collected by the camera 3 and the distance between the camera 3 and the special movable objects recorded in the pre-collected images of the special movable objects.

The image obtaining module 31 obtains a number of continuous images of the scene captured by the camera 3 during a period from a time of detecting the operation on the input unit 2 to a time of detecting the operation on the steering wheel 8.

The model creating module 32 creates a number of 3D models of the scene corresponding to the obtained images of the scene according to the obtained images of the scene and the distance between the camera 3 and each object captured by the camera 3.

The image analyzing module 33 determines a direction to be turned (hereinafter turning direction), for example, left direction, according to the operation on the input unit 2. The image analyzing module 33 further determines whether one or more movable objects exist behind the vehicle 100 in the turning direction of the vehicle 100.

In detail, the image analyzing module 33 extracts data from a part of each of the 3D models of the scene corresponding to the shape of the one or more objects appearing in the created 3D model of the scene. As well as the part of each of the 3D models of the scene represents the environment behind the vehicle 100 in the turning direction of the vehicle 100. The image analyzing module 33 compares the extracted data from the part of each of the 3D models of the scene with characteristic features of each of the preset 3D models of the special movable objects to determine whether one or more movable object exist in the part of each of the created 3D models of the scene. If one or more of the extracted data from the part of each of the 3D models of the scene match the characteristic features of one of the preset 3D models of the special movable objects, the image analyzing module 33 determines that one or more movable objects exist in the part of each of the created 3D models of the scene, and accordingly determines that one or more movable objects exist behind the vehicle 100 in the turning direction of the vehicle 100. If no extracted data from the part of at least one 3D model of the scene matches the characteristic features of any of the preset 3D models of the special movable objects, the image analyzing module 33 determines that no movable object exists in the part of each of the created 3D models of the scene, and determines that no movable object exists behind the vehicle 100 in the turning direction of the vehicle 100 accordingly.

The speed determining module 34 determines the speed of one movable object according to the created 3D models of the scene, the capturing speed of the camera 3, and the speed of the vehicle 100 detected by the speed detection unit 4 when one or more movable objects exist behind the vehicle 100 in the turning direction of the vehicle 100. In detail, the speed determining module 34 randomly selects two continuous or discontinuous 3D models of the scene from the created 3D models of the scene. The speed determining module 34 determines one movable object, determines each shortest distance between the determined movable object and the camera 3 in each selected 3D models of the scene, and determines the movement distance of the movable object relative to the vehicle 100 is equal to an absolute value of a difference value of two shortest distances. In the embodiment, the speed determining module 34 determines that one movable object is the movable object behind the turning direction of the vehicle 100 when only one movable object exists behind the turning direction of the vehicle 100. The speed determining module 34 determines which movable object is closest to the vehicle 100 in the later selected 3D model of the scene when more than one movable objects exist behind the turning direction of the vehicle 100. The speed determining module 34 determines the number of the images of the scene between two images of the scene corresponding to the selected two 3D models of the scene. In addition, the speed determining module 34 determines the time that the camera 3 captures the determined number of images of the scene is equal to the number of the images of the scene divided by the stored capturing speed of the camera 3. The speed determining module 34 determines that the speed of the determined movable object relative to the vehicle 100 is equal to the determined movement distance of the movable object relative to the vehicle 100 divided by the determined time. The speed determining module 34 further obtains speed of the vehicle 100 detected by the speed detection unit 4, and determines the speed of the determined movable object is equal to a sum of the speed of the determined movable object relative to the vehicle 100 and the speed of the vehicle 100.

FIG. 2 illustrates that the angle determining module 35 determines the turning angle of the vehicle 100 according to the determined speed of the determined movable object, the obtained speed of the vehicle 100, the safe distance, the turning time of the vehicle 100, and the shortest distance between the vehicle 100 and the determined movable object in the latest created 3D model of the scene. In detail, the angle determining module 35 determines a distance that the determined movable object can be approached to the vehicle 100 according to a formula: d=x−a, where, “d” represents the distance that the determined movable object can be approached to the vehicle 100, “x” represents the shortest distance between the vehicle 100 and the determined movable object in the latest created 3D model of the scene, and “a” represents the safe distance. The angle determining module 35 determines the turning angle of the vehicle 100 according to a formula: d=(V2−V1 cos θ)*t, where, “d” represents the distance that the determined movable object can be approached to the vehicle 100, “V2” represents the speed of the determined movable object, “V1” represents the speed of the vehicle 100, “θ” represents the turning angle of the vehicle 100, and “t” represents the turning time of the vehicle 100.

The executing module 36 controls the driving unit 5 to drive the limiting unit 6 to limit the largest turning angle of the front wheels 7 as the determined turning angle of the vehicle 100.

In the embodiment, the vehicle assistance device 1 is further connected to an angle obtaining unit 9. The angle obtaining unit 9 detects the turning angle of the steering wheel 8. The executing module 36 controls the driving unit 5 to drive the limiting unit 6 to limit the largest turning angle of the front wheels 7 as the determined turning angle of the vehicle 100 when the turning angle of the steering wheel 8 detected by the angle obtaining unit 9 is greater than the turning angle of the vehicle 100.

In the embodiment, the executing module 36 further controls the driving unit 5 to drive the limiting unit 6 to provide an extra resistance to the steering wheel 8 to prompt the driver not to continue enlarging the turning angle of the steering wheel 8 when the turning angle of the steering wheel 8 detected by the angle obtaining unit is greater than the turning angle of the vehicle 100.

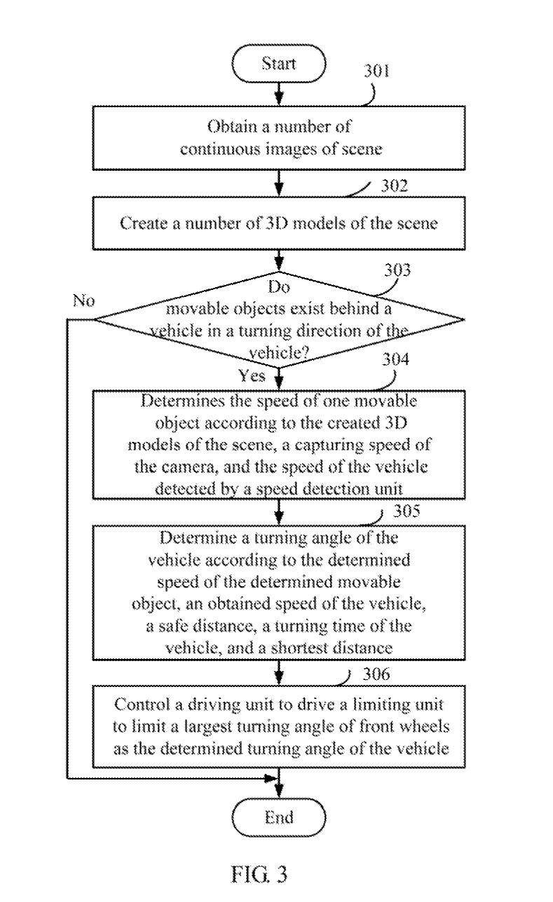

FIG. 3 shows a vehicle assistance method in accordance with an exemplary embodiment.

In 301, the image obtaining module obtains a number of continuous images of the scene captured by the camera during a period from a time of detecting the operation on the input unit to a time of detecting the operation on the steering wheel 8 in response to user operation on the input unit.

In 302, the model creating module creates a number of 3D models of the scene corresponding to the obtained images of the scene according to the obtained images of the scene and the distance between the camera and each object captured by the camera.

In 303, the image analyzing module determines a turning direction, for example, left direction, according to the operation on the input unit. The image analyzing module further determines whether one or more movable objects exist behind the vehicle in the turning direction of the vehicle. In detail, the image analyzing module extracts data from a part of each of the 3D models of the scene corresponding to the shape of the one or more objects appearing in the created 3D model of the scene, the part of each 3D model of the scene represents the environment behind the vehicle in the turning direction of the vehicle. The image analyzing module compares the extracted data from the part of each of the 3D models of the scene with characteristic features of each of the preset 3D models of the special movable objects to determine whether one or more movable object exist in the part of each of the created 3D models of the scene. If one or more of the extracted data from the part of each of the 3D models of the scene match the characteristic features of one of the preset 3D models of the special movable objects, the image analyzing module 33 determines that one or more movable objects exist in the part of each of the created 3D models of the scene, and accordingly determines that one or more movable objects exist behind the vehicle in the turning direction of the vehicle. If no extracted data from the part of at least one 3D model of the scene matches the characteristic features of any of the preset 3D models of the special movable objects, the image analyzing module determines that no movable object exists in the part of each of the created 3D models of the scene, and accordingly determines that no movable object exists behind the vehicle in the turning direction of the vehicle. When one or more movable objects exist behind the vehicle in the turning direction of the vehicle, the procedure goes to 304. When no movable object exists behind the vehicle in the turning direction of the vehicle 100, the procedure stops at 303.

In 304, the speed determining module determines the speed of one movable object according to the created 3D models of the scene, the capturing speed of the camera, and the speed of the vehicle detected by the speed detection unit. In detail, the speed determining module randomly selects two continuous or discontinuous 3D models of the scene from the created 3D models of the scene. The speed determining module determines one movable object, determines each shortest distance between the determined movable object and the camera in each two selected 3D models of the scene, and determines the movement distance of the movable object relative to the vehicle is equal to an absolute value of a difference value of two shortest distances. In the embodiment, the speed determining module determines that one movable object is the movable object behind the vehicle in the turning direction of the vehicle when only one movable object exists behind the vehicle in the turning direction of the vehicle. The speed determining module determines which movable object is closest to the vehicle in the later selected 3D model of the scene when more than one movable objects exist behind the vehicle in the turning direction of the vehicle. The speed determining module determines the number of the images of the scene between two images of the scene corresponding to the two selected 3D models of the scene, and determines the time that the camera captures the determined number of the image of the scene is equal to the number of the images of the scene divided by the stored capturing speed of the camera. The speed determining module determines that the speed of the determined movable object relative to the vehicle is equal to the determined movement distance of the movable object relative to the vehicle divided by the determined time. The speed determining module further obtains the speed of the vehicle detected by the speed detection unit, and determines the speed of the determined movable object is equal to a sum of the speed of the determined movable object relative to the vehicle and the speed of the vehicle.

In 305, the angle determining module determines the turning angle of the vehicle according to the determined speed of the determined movable object, the obtained speed of the vehicle, the safe distance, the turning time of the vehicle, and the shortest distance between the vehicle and the determined movable object in the latest created 3D model of the scene. In detail, the angle determining module 35 determines a distance that the determined movable object can be approached to the vehicle according to a formula: d=x−a, where “d” represents the distance that the determined movable object can be approached to the vehicle, “x” represents the shortest distance between the vehicle and the determined movable object in the latest created 3D model of the scene, and “a” represents the safe distance. The angle determining module determines the turning angle of the vehicle according to a formula: d=(V2−V1 cos θ)*t, where “d” represents the distance that the determined movable object can be approached to the vehicle, “V2” represents the speed of the determined movable object, “V1” represents the speed of the vehicle 100, “θ” represents the turning angle of the vehicle, and “t” represents the turning time of the vehicle.

In 306, the executing module controls the driving unit to drive the limiting unit to limit the largest turning angle of the front wheels as the determined turning angle of the vehicle.

Although the present disclosure has been specifically described on the basis of the exemplary embodiment thereof, the disclosure is not to be construed as being limited thereto. Various changes or modifications can be made to the embodiment without departing from the scope and spirit of the disclosure.

What is claimed is:

1. A vehicle assistance device, comprising:
a storage unit storing a plurality of preset 3D models of the special movable objects, a capturing speed of the camera, and a safe distance between a vehicle and the movable object;
a processor;
one or more programs stored in the storage unit, executable by the processor, the one or more programs comprising:
an image obtaining module configured to obtain a plurality of continuous images of scene captured by at least one camera in a period from a time of detecting an operation on an input unit to a time of detecting an operation on a steering wheel of the vehicle; each of the images comprising a distance information indicating distances between the at least one camera that captures the image and each object captured by the at least one camera;
a model creating module operable to create a plurality of 3D models of the scene corresponding to the obtained images of the scene according to the obtained images of the scene and the distance between the camera and each object captured by the corresponding camera;
an image analyzing module operable to determine a turning direction according to the operation on the input unit, and compare the created 3D models of scene with the stored preset 3D models of the special movable objects to determine whether one or more movable objects exist behind the vehicle in the turning direction of the vehicle;
a speed determining module configured to determine a speed of one movable object according to the created 3D models of the scene, the stored capturing speed of the camera, and the speed of the vehicle detected by a speed detection unit when one or more movable object exist behind the vehicle in the turning direction of the vehicle;
an angle determining module configured to determine a turning angle of the vehicle according to the determined speed of the determined movable object, the obtained speed of the vehicle, the stored safe distance between the vehicle and the movable object, a stored turning time of the vehicle, and the shortest distance between the vehicle and the determined movable object in the latest created 3D model of the scene; and
an executing module configured to control a driving unit to drive a limiting unit to limit a largest turning angle of front wheels of the vehicle as the determined turning angle of the vehicle.

2. The vehicle assistance device as described in claim 1, wherein the speed determining module is configured to:
randomly select two continuous or discontinuous 3D models of the scene from the created 3D models of the scene;
determine one movable object, determine each shortest distance between the determined movable object and the camera in each selected 3D models of the scene, and determine the movement distance of the movable object relative to the vehicle is equal to an absolute value of a difference value of two shortest distances;
determine the number of the images of the scene between two images of the scene corresponding to the selected two 3D models of the scene, and determine the time that the camera captures the determined number of images of the scene is equal to the number of the images of the scene divided by the stored capturing speed of the camera;
determine that the speed of the determined movable object relative to the vehicle is equal to the determined movement distance of the movable object relative to the vehicle divided by the determined time; and
obtain the speed of the vehicle detected by the speed detection unit, and determine the speed of the determined movable object is equal to a sum of the speed of the determined movable object relative to the vehicle and the speed of the vehicle.

3. The vehicle assistance device as described in claim 2, wherein the speed determining module is configured to determine that one movable object is the movable object behind the vehicle in the turning direction of the vehicle when only one movable object exists behind the vehicle in the turning direction of the vehicle, and determine which movable object closest to the vehicle in the later selected 3D model of the scene when more than one movable objects exist behind the vehicle in the turning direction of the vehicle.

4. The vehicle assistance device as described in claim 1, wherein the angle determining module is configured to:
determine a distance that the determined movable object can be approached to the vehicle according to a formula: d=x−a, where, “d” represents the distance that the determined movable object can be approached to the vehicle, “x” represents the shortest distance between the vehicle and the determined movable object in the latest created 3D model of the scene, and “a” represents the stored safe distance between the vehicle and the movable object; and
determine the turning angle of the vehicle according to a formula: d=(V2−V1 cos θ)*t, where, “d” represents the distance that the determined movable object can be approached to the vehicle, “V2” represents the speed of the determined movable object, “V1” represents the obtained speed of the vehicle, “θ” represents the turning angle of the vehicle, and “t” represents a stored turning time of the vehicle.

5. The vehicle assistance device as described in claim 1, wherein the executing module is configured to control the driving unit to drive the limiting unit to limit the largest turning angle of the front wheels of the vehicle as the determined turning angle of the vehicle when the turning angle of the steering wheel of the vehicle detected by the angle obtaining unit is greater than the turning angle of the vehicle.

6. The vehicle assistance device as described in claim 1, wherein the executing module is further configured to control the driving unit to drive the limiting unit to provide an extra resistance to the steering wheel of the vehicle to prompt the driver not to continue enlarging the turning angle of the steering wheel of the vehicle when the turning angle of the steering wheel of the vehicle detected by the angle obtaining unit is greater than the turning angle of the vehicle.

7. A vehicle assistance method comprising:
obtaining a plurality of continuous images of scene captured by at least one camera during a period from a time of detecting an operation on an input unit to a time of detecting an operation on a steering wheel of a vehicle; each of the images comprising a distance information indicating distances between the at least one camera that captures the image and each object captured by the at least one camera;
creating a plurality of 3D models of the scene corresponding to the obtained images of the scene according to the obtained images of the scene and the distance between the camera and each object captured by the corresponding camera;
determining a turning direction according to the operation on the input unit, and comparing the created 3D models of scene with stored preset 3D models of the special movable objects to determine whether one or more movable objects exist behind the vehicle in the turning direction of the vehicle;
determining a speed of one movable object according to the created 3D models of the scene, a stored capturing speed of the camera, and the speed of the vehicle detected by a speed detection unit when one or more movable object exist behind the vehicle in the turning direction of the vehicle;
determining a turning angle of the vehicle according to the determined speed of the determined movable object, the obtained speed of the vehicle, a stored safe distance between the vehicle and the movable object, a stored turning time of the vehicle, and the shortest distance between the vehicle and the determined movable object in the latest created 3D model of the scene; and
controlling a driving unit to drive a limiting unit to limit a largest turning angle of two front wheels of the vehicle as the determined turning angle of the vehicle.

8. The vehicle assistance method as described in claim 7, wherein the step of “determining a speed of one movable object” comprises:
randomly selecting two continuous or discontinuous 3D models of the scene from the created 3D models of the scene;
determining one movable object, determining each shortest distance between the determined movable object and the camera in each selected 3D models of the scene, and determining the movement distance of the movable object relative to the vehicle is equal to an absolute value of a difference value of two shortest distances;
determining the number of the images of the scene between two image of the scene corresponding to the selected two 3D models of the scene, and determining the time that the camera captures the determined number of images of the scene is equal to the number of the images of the scene divided by the stored capturing speed of the camera;
determining that the speed of the determined movable object relative to the vehicle is equal to the determined movement distance of the movable object relative to the vehicle divided by the determined time; and
obtaining the speed of the vehicle detected by the speed detection unit, and determining the speed of the determined movable object is equal to a sum of the speed of the determined movable object relative to the vehicle and the speed of the vehicle.

9. The vehicle assistance method as described in claim 8, wherein the method further comprises:
determining that one movable object is the movable object behind the vehicle in the turning direction of the vehicle when only one movable object exists behind the vehicle in the turning direction of the vehicle; and
determining which movable object is closest to the vehicle in the later selected 3D model of the scene when more than one movable objects exist behind the vehicle in the turning direction of the vehicle.

10. The vehicle assistance method as described in claim 7, wherein the step of “determining a turning angle of the vehicle” further comprises:
determining a distance that the determined movable object can be approached to the vehicle according to a formula: d=x−a, where, “d” represents the distance that the determined movable object can be approached to the vehicle, “x” represents the shortest distance between the vehicle and the determined movable object in the latest created 3D model of the scene, and “a” represents the stored safe distance between the vehicle and the movable object; and
determining the turning angle of the vehicle according to a formula: d=(V2−V1 cos θ)*t, where, “d” represents the distance that the determined movable object can be approached to the vehicle, “V2” represents the speed of the determined movable object, “V1” represents the obtained speed of the vehicle, “θ” represents the turning angle of the vehicle, and “t” represents a stored turning time of the vehicle.

11. The vehicle assistance method as described in claim 7, wherein the method further comprises:
controlling the driving unit to drive the limiting unit to limit the largest turning angle of the front wheels of the vehicle as the determined turning angle of the vehicle when the turning angle of the steering wheel of the vehicle detected by the angle obtaining unit is greater than the turning angle of the vehicle.

12. The vehicle assistance method as described in claim 7, wherein the method further comprises:
controlling the driving unit to drive the limiting unit to provide an extra resistance to the steering wheel of the vehicle to prompt the driver not to continue enlarging the turning angle of the steering wheel of the vehicle when the turning angle of the steering wheel of the vehicle detected by the angle obtaining unit is greater than the turning angle of the vehicle.

13. A non-transitory storage medium storing a set of instructions, the set of instructions capable of being executed by a processor of a vehicle assistance device, causing the vehicle assistance device to perform a vehicle assistance method, the method comprising:
obtaining a plurality of continuous images of scene captured by least one camera during a period from a time of detecting an operation on an input unit to a time of detecting an operation on a steering wheel of a vehicle; each of the images comprising a distance information indicating distances between the at least one camera that captures the image and each object captured by the at least one camera;
creating a plurality of 3D models of the scene corresponding to the obtained images of the scene according to the obtained images of the scene and the distance between the camera and each object captured by the corresponding camera;
determining a turning direction according to the operation on the input unit, and comparing the created 3D models of scene with stored preset 3D models of the special movable objects to determine whether one or more movable objects exist behind the vehicle in the turning direction of the vehicle;
determining a speed of one movable object according to the created 3D models of the scene, a stored capturing speed of the camera, and the speed of the vehicle detected by an speed detection unit when one or more movable object exist behind the vehicle in the turning direction of the vehicle;
determining a turning angle of the vehicle according to the determined speed of the determined movable object, the obtained speed of the vehicle, a stored safe distance between the vehicle and the movable object, a stored turning time of the vehicle, and the shortest distance between the vehicle and the determined movable object in the latest created 3D model of the scene; and
controlling a driving unit to drive a limiting unit to limit a largest turning angle of two front wheels of the vehicle as the determined turning angle of the vehicle.

14. The non-transitory storage medium as described in claim 13, wherein the step of “determining a speed of one movable object” comprises:
randomly selecting two continuous or discontinuous 3D models of the scene from the created 3D models of the scene;
determining one movable object, determining each shortest distance between the determined movable object and the camera in each selected 3D models of the scene, and determining the movement distance of the movable object relative to the vehicle is equal to an absolute value of a difference value of two shortest distances;
determining the number of the images of the scene between two image of the scene corresponding to the selected two 3D models of the scene, and determining the time that the camera captures the determined number of images of the scene is equal to the number of the images of the scene divided by the stored capturing speed of the camera;
determining that the speed of the determined movable object relative to the vehicle is equal to the determined movement distance of the movable object relative to the vehicle divided by the determined time; and
obtaining the speed of the vehicle detected by the speed detection unit, and determining the speed of the determined movable object is equal to a sum of the speed of the determined movable object relative to the vehicle and the speed of the vehicle.

15. The non-transitory storage medium as described in claim 14, wherein the method further comprises:
determining that one movable object is the movable object behind the vehicle in the turning direction of the vehicle when only one movable object exists behind the vehicle in the turning direction of the vehicle; and
determining which movable object is closest to the vehicle in the later selected 3D model of the scene when more than one movable objects exist behind the vehicle in the turning direction of the vehicle.

16. The non-transitory storage medium as described in claim 13, wherein the step of “determining a turning angle of the vehicle” further comprises:
determining a distance that the determined movable object can be approached to the vehicle according to a formula: d=x−a, where, “d” represents the distance that the determined movable object can be approached to the vehicle, “x” represents the shortest distance between the vehicle and the determined movable object in the latest created 3D model of the scene, and “a” represents the stored safe distance between the vehicle and the movable object; and
determining the turning angle of the vehicle according to a formula:
d=(V2−V1 cos θ)*t, where, “d” represents the distance that the determined movable object can be approached to the vehicle, “V2” represents the speed of the determined movable object, “V1” represents the obtained speed of the vehicle, “θ” represents the turning angle of the vehicle, and “t” represents a stored turning time of the vehicle.

17. The non-transitory storage medium as described in claim 13, wherein the method further comprises:
controlling the driving unit to drive the limiting unit to limit the largest turning angle of the front wheels of the vehicle as the determined turning angle of the vehicle when the turning angle of the steering wheel of the vehicle detected by the angle obtaining unit is greater than the turning angle of the vehicle.

18. The non-transitory storage medium as described in claim 13, wherein the method further comprises:
controlling the driving unit to drive the limiting unit to provide an extra resistance to the steering wheel of the vehicle to prompt the driver not to continue enlarging the turning angle of the steering wheel of the vehicle when the turning angle of the steering wheel of the vehicle detected by the angle obtaining unit is greater than the turning angle of the vehicle.
